(19) United States
(12) Patent Application Publication
(10) Pub. No.: US 2006/0121851 A1
(43) Pub. Date: Jun. 8, 2006

(54) Ultra-wideband security system

(76) Inventors: Steve Moore, Escondido, CA (US); John Santhoff, Carlsbad, CA (US)

Correspondence Address: PULSE-LINK, INC., 1969 KELLOGG AVENUE, CARLSBAD, CA, 92008, US

(21) Appl. No.: 11/005,597

(22) Filed: Dec. 6, 2004

(51) Int. Cl. H04B 7/00

(52) U.S. Cl. 455/41.2; 455/73

(57) ABSTRACT

An ultra-wideband security and tracking apparatus, system and method are provided. In one embodiment, an ultra-wideband device is coupled to luggage or other items to be transported. The ultra-wideband device determines its location and reports its location and other information to an access point. The access point may then report the information to a remote location. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to ultra-wideband communications. More particularly, the invention concerns an ultra-wideband security system.

### BACKGROUND OF THE INVENTION

The Information Age is upon us. Access to vast quantities of information through a variety of different communication systems are changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as movies-on-demand and video teleconferencing demand high data transmission rates. Another example is interactive video in homes and offices. Moreover, traffic across the Internet continues to increase, and with the introduction of new applications, such as the convergence of voice and Internet data, traffic will only increase at a faster rate. Consequently, carriers and service providers are overhauling the entire network infrastructure—including switches, routers, backbone, and the last mile (i.e., the local loop)—in an effort to provide more bandwidth.

Many industries use radio frequency technology to transmit data. Conventional radio frequency technology employs continuous sine waves that are transmitted with data embedded in a modulation of the sine waves' amplitude or frequency. For example, a conventional cellular phone must operate at a particular frequency band of a particular width in a prescribed frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

Radio frequency (RF) technologies are pervasive in today's society. RF impacts everything from the way we cook our food through the use of microwave ovens, the way we communicate through wireless technologies such as cellular phones, to the way we entertain ourselves through cable television. RF is additionally useful in tracking objects through the use of RF identification (RFID) tags. RF technologies may additionally be used to geo-locate objects through triangulation from multiple RF sources.

One industry that may further benefit from the use of RFID tags is the transportation industry. RF tags may increase the level of security at our airports. Some wireless communications devices have superior properties that make them more suitable for airport security. In this environment a device should be low cost, low power, have the ability to coexist with other RF devices within the spectrum, and have the ability to carry large amounts of data. Therefore, there exists a need for apparatus and methods to improve security for the transportation industry.

### SUMMARY OF THE INVENTION

A system, method and article of manufacture are provided for tracking an object. In one embodiment of the present invention, an ultra-wideband device is affixed to the object to be tracked. When the object is placed on a vehicle, it communicates with a network access point installed on the vehicle, or at another location. The object may determine its geographic location within the vehicle and report this information to the network access point. The network access point may then report the object's location to another location such as an airport terminal.

One feature of the present invention is that it enables validation of luggage with aircraft passengers. That is, when luggage is loaded onto an aircraft, a network access point in the cargo hold, or other location on the aircraft, or adjacent to the aircraft, collects data from the luggage. A system at the airport terminal, on the aircraft, or at another location may then validate the luggage on the airplane against a passenger list, or against a cargo list.

Another feature of the present invention is that it allows for luggage and other packages to be tracked against passengers travel itineraries thus reducing the probability of misdirected or lost luggage. If a piece of luggage is lost, it can communicate its owner's information and travel itinerary directly to any available access point and the luggage may be redirected to the proper location.

Another embodiment of the present invention will enable a shipping customer to track a package almost real-time while it is in transit. The package will periodically transmit its location, which may then be reported to a central location. This information may then be processed and displayed on a shipping companies' web page allowing customers to gain almost real-time access to their package's location.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is an illustration of different communication methods;

FIG. 2 is an illustration of two ultra-wideband pulses;

FIG. 3 is a chart of ultra-wideband emission limits as established by the Federal Communications Commission on Apr. 22, 2002;

FIG. 4a is an illustration of two embodiments of an ultra-wideband tag constructed according to the present invention;

FIG. 4b is a side view of two embodiments an ultra-wideband tag constructed according to the present invention; and

FIG. 5 is an illustration of a security system constructed according to one embodiment of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides systems, methods and articles of manufacture for tracking an object and improving transportation security. Briefly, an ultra-wideband (UWB) tag is affixed to an object to be shipped, such as an item of luggage, a package, or any other item of interest. When the tag is activated it periodically transmits a beacon signal. Once communication has been established with a network access point, the tag calculates its geo-position (i.e., geographic location). The information encoded onto the tag and the geographic location of the tag is then transmitted to the network access point.

One feature of the present invention is that it allows airport security personnel to validate the luggage within an airplane's luggage compartment against a passenger load list. In this manner security personnel can ensure that every object on the plane is the property of a passenger on that plane.

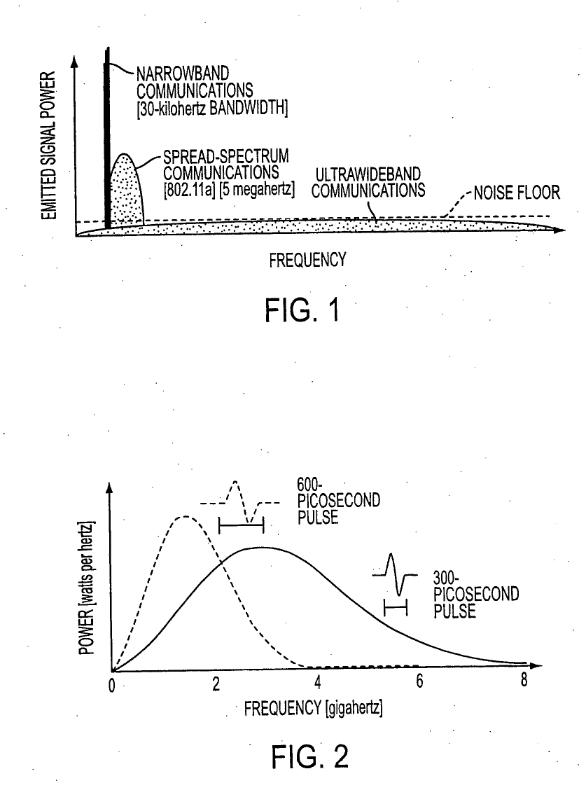

Referring to FIGS. 1 and 2, ultra-wideband (UWB) communication employs discrete pulses of electromagnetic energy that are emitted at, for example, nanosecond or picosecond intervals (generally tens of picoseconds to a few hundred nanoseconds in duration). For this reason, ultra-wideband is often called “impulse radio.” That is, the UWB pulses may be transmitted without modulation onto a sine wave, or a sinusoidal carrier, in contrast with conventional carrier wave communication technology. UWB generally requires neither an assigned frequency nor a power amplifier.

Alternate embodiments of UWB may be achieved by mixing base band pulses (i.e., information-carrying pulses), with a carrier wave that controls a center frequency of a resulting signal. The resulting signal is then transmitted using discrete pulses of electromagnetic energy, as opposed to transmitting a substantially continuous sinusoidal signal.

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 2, which illustrates two typical UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency, as shown in FIG. 1. Either of the pulses shown in FIG. 2 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Also, because the UWB pulses are spread across an extremely wide frequency range, the power sampled in, for example, a one megahertz bandwidth is very low. For example, UWB pulses of one nano-second duration and one-milliwatt average power (0 dBm) spreads the power over the entire one-gigahertz frequency band occupied by the pulse. The resulting power density is thus 1 milliwatt divided by the 1,000 MHz pulse bandwidth, or 0.001 milliwatt per megahertz (−30 dBm/MHz). This is below the signal level of any wire media system and therefore does not interfere with the demodulation and recovery of signals transmitted by the CATV provider.

Generally, in the case of wireless communications, a multiplicity of UWB pulses may be transmitted at relatively low power density (milliwats per megahertz). However, an alternative UWB communication system may transmit at a higher power density. For example, UWB pulses may be transmitted between 30 dBm to −50 dBm.

UWB pulses, however, transmitted through many wire media will not interfere with wireless radio frequency transmissions. Therefore, the power (sampled at a single frequency) of UWB pulses transmitted though wire media may range from about +30 dBm to about −140 dBm.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may expand the use of UWB communication technology.

The April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2. However, the present invention is not limited to UWB as defined by the current FCC definition. As discussed above, UWB is a form of impulse communications, and some embodiments may not fit within the current FCC definition.

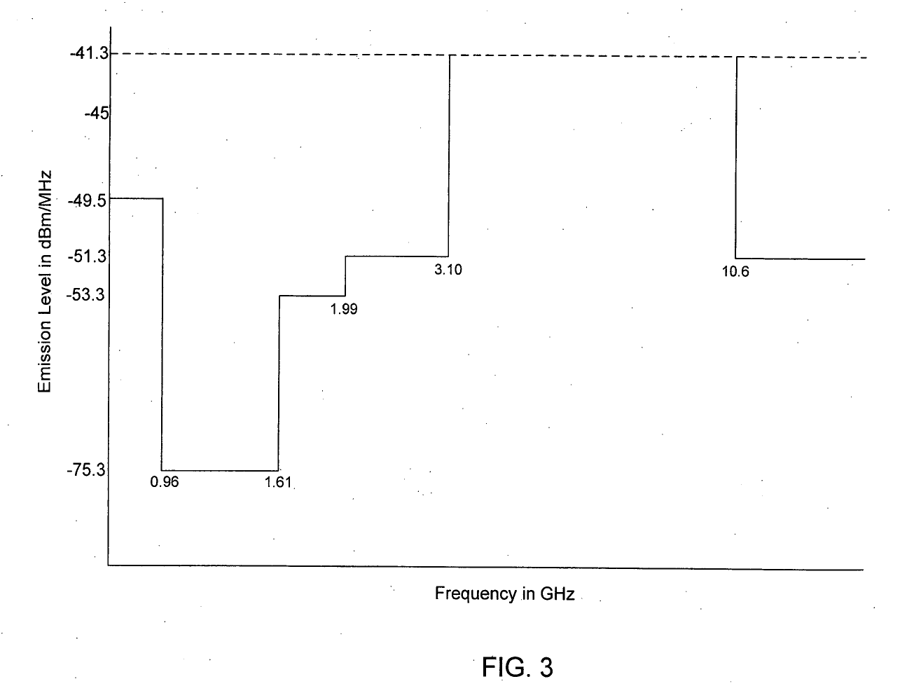

FIG. 3 illustrates the ultra-wideband emission limits for indoor systems (in the United States) mandated by the April 22 Report and Order. The Report and Order constrains UWB communications to the frequency spectrum between 3.1 GHz and 10.6 GHz, with intentional emissions to not exceed −41.3 dBm/MHz. The report and order also established emission limits for hand held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has a 242-nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga-pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Thus, described above are three different methods of ultra-wideband (UWB) communication. It will be appreciated that the present invention may be employed by any of the above-described UWB methods, or others yet to be developed.

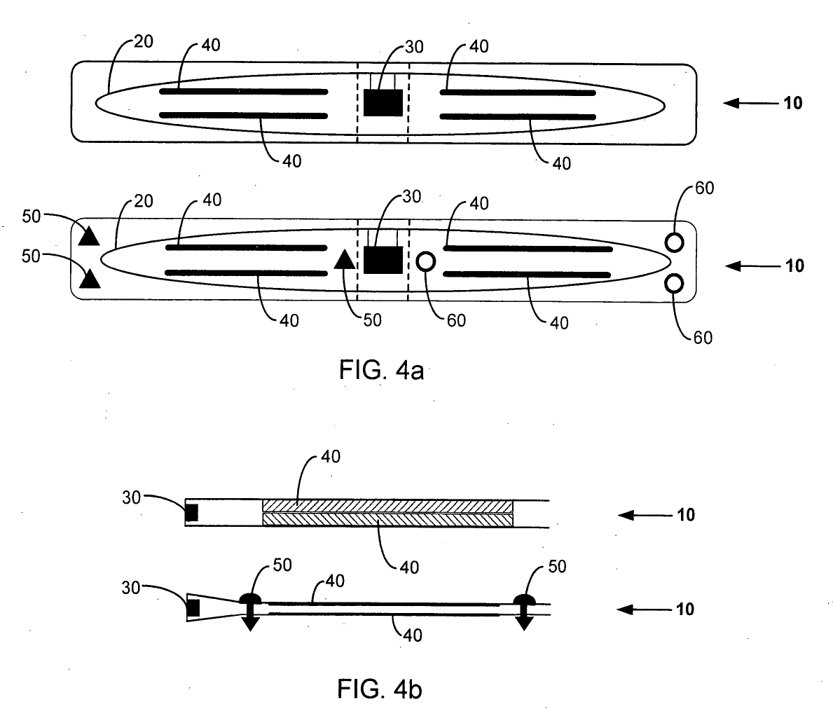

Referring to FIGS. 4a and 4b, which illustrates two embodiments of a UWB enabled tag 10. The tag comprises an antenna 20, an application specific integrated circuit (ASIC) 30, and one or more battery elements 40. The ASIC 30 generally comprises an integrated circuit that is created to perform a specific job or task. In one embodiment, the ASIC 30 receives information about the luggage, the owner of the luggage, the luggage destination, and may also include location determination logic or instructions, as well as logic for when to transmit location information, passenger information, or luggage information. Alternative ASICs 30 may include other appropriate functionality. In one embodiment, the tag 10 may include fastening element(s), which in one embodiment may include a number of posts 50 and post receptacles 60. One feature of this embodiment is that proper alignment of the material making up the battery elements 40 is ensured since the posts 50 and receptacles 60 are placed on the tag 10 to assist in alignment. It will be appreciated that other types of fasteners may be employed.

FIG. 4b shows two side views of UWB tag 10 when closed. In one embodiment, the battery elements 40 may contact each other, creating a battery, and in another embodiment, the battery elements 40 may not be required contact each other.

In another embodiment, UWB tag 10 may additionally comprise a magnetic strip (not shown) or a barcode (not shown). In this embodiment, information may be encoded onto the magnetic strip, or into the barcode. One feature of this embodiment is that the barcode or the magnetic strip is a more permanent storage media and a lost bag whose UWB tag 10 has stopped functioning may still be identified by the information encoded on one of these media.

Referring again to FIGS. 4a and 4b, in one embodiment, the battery elements 40 may comprise one or more thin flexible batteries. In this embodiment, the electrolyte and anode are printed, or otherwise deposited on one portion of UWB tag 10. The cathode is printed, or otherwise deposited on the opposing side of UWB tag 10. Contact between the battery elements 40 occurs when UWB tag 10 is closed and affixed to the luggage or parcel. Once contact is made the battery elements 40 begin to supply power to the UWB tag 10. Alternatively, the electrolyte and cathode may be printed on one side of the UWB tag 10, with the anode on the opposing side of the UWB tag 10. In another embodiment, each of the battery elements 40 contains anode, cathode, and electrolyte. In this embodiment, closing, or otherwise manipulating the UWB tag 10 activates the battery. Using battery elements 40 as described herein has a number of advantages. The battery elements 40 can be very thin having a thickness on the order of a few tenths of a millimeter to tens of millimeters. In addition, the battery elements 40 can be integrated, or otherwise incorporated directly into the material of the UWB tag 10. In either of these embodiments, the battery elements 40 can be manufactured using a low cost silk screening process, or other inexpensive manufacturing methods. Using printed battery elements 40 eliminates the need for traditional batteries, thus eliminating the cost and weight associated with conventional batteries. Additionally, printed battery elements 40 have the flexibility to withstand any bending that may occur during transport and handling of the tag 10.

Referring again to FIG. 4a, in another embodiment UWB tag 10, the antenna 20 may comprise a flexible antenna 20. In this embodiment, the antenna 20 may employ a metallic conductive ink that is printed, or otherwise deposited onto the surface of the UWB tag 10. Using this type of antenna construction reduces the cost of the UWB tag 10. In addition, this embodiment antenna may be flexible and thus is suited to the airport luggage-handling environment.

One feature of the present invention is that the UWB tag 10 may be disposable, which is achievable due to its low manufacturing cost. When an airline passenger checks luggage at the airport, the UWB tag 10 is issued. When affixed to the passenger's luggage, the UWB tag 10 is closed around the luggage handle in the usual manner and can be held in place by posts 50 and post receptacles 60. When the battery elements 40 come into contact with each other they power the UWB tag 10. The battery elements 40 may be printed onto the UWB tag 10 with any material suitable of forming a battery and providing power when in contact with each other. The ASIC 30 may then receive encoded passenger information from the terminal, through antenna 20. The passenger information that may be encoded into the ASIC 30 may include the passenger's name, address, phone number, age, physical description, citizenship, nationality, travel itinerary, and any other information of interest. Alternatively, the information encoded may comprise a unique passenger identification number. This identification number may be referenced in a database, which may contain information about the passenger. Once activated, the UWB tag's transmitter, located within the ASIC 30, may remain dormant until the luggage is loaded onto a transportation vehicle. Alternatively, the ASIC 30 may, through the antenna 20, periodically beacon until communication with a network access point is established. In one embodiment, the ASIC 30 may remain active so that it may receive additional information, such as changing geographic location, or other information throughout the lifetime of the tag 10. In this embodiment, the ASIC 30 may only transmit when queried by a network access point. Alternatively, the ASIC 30 may be programmed, or include logic to deactivate after a fixed time period, and then may re-activate at another time period, such as when the aircraft is expected to arrive at its destination.

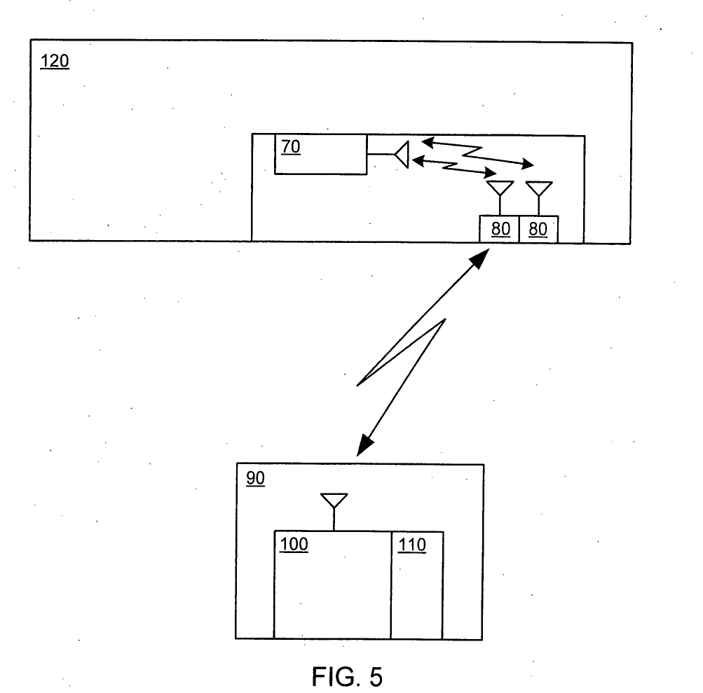

Referring now to FIG. 5, once the tagged luggage 80 is loaded onto an aircraft 120 or other transportation vehicle, the UWB tag 10 communicates with an installed network access point 70 within the vehicle 120, it may communicate with an access point in the terminal (not shown), or with a portable access point carried by a airline employee or located in another vehicle. The tagged luggage 80 may then determine their geographic location themselves within the luggage compartment. Radio frequency geographic location methods are generally well known in the art. The UWB tag 10 may then transmit passenger information and/or luggage location to the network access point 70, which may also be transmitted to a remote location 90, such as an airline's central processing facility. In this embodiment, within remote location 90 a data terminal 100 receives the information from network access point 70 and may cross-reference this information with a database 110 or other predetermined list of information. Database 110 may be co-located within data terminal 100 or alternatively may be located at a different location. The passenger information may include but is not limited to the passengers name, age, itinerary, or address, or other information as discussed above. Alternatively, the passenger information may include a passenger identification number, which may be used to reference additional information.

When a passenger takes a piece of carry-on luggage through airport security, a UWB tag 10 may be affixed to the carry-on. When activated this UWB tag 10 may beacon periodically within the passenger areas of the airport. If a piece of carry-on luggage is inadvertently left within the airport, the network access point may identify the passenger who left the bag based on the beacon signal. One feature of this embodiment is that tagged articles can be tracked throughout the airport and lost items may be recovered.

In one embodiment of the present invention, a network access point 70 may command all, or specifically identified UWB tags 10 to shut down transmission for a specified time period. One feature of this embodiment is that battery 40 life may be extended by powering down both transmission and reception for a fixed amount of time. Alternatively, the UWB tags 10 may be commanded to cease transmission until an activation signal is received. In this embodiment the network access point 70 may tell the UWB tags 10 to cease transmission during take-off and landing of an aircraft or the UWB tag 10 may cease transmission until the flight has reached its destination. The UWB tag 10 may be taken off at the final destination by airport personnel or alternatively may be disposed of by the customer. In one embodiment, once the UWB tag 10 is removed from the luggage the battery elements 40 connection is severed and the UWB tag 10 stops working. Alternatively, the UWB tag 10 may continue to operate until the battery elements 40 become exhausted.

In another embodiment of the present invention, UWB tags 10 may be affixed to parcels for shipment. One feature of this embodiment is that a shipping customer may be able to track their shipment in real-time over the World Wide Web, or by phone, PDA or other device. In this embodiment, the UWB tag 10 is encoded with the sender and destination information. The UWB tag 10 may be additionally encoded with the package's weight, contents, special handling information, and any other information. One feature of this embodiment is that by encoding an package's weight onto the UWB tag 10, the UWB tag 10 may assist in properly achieving a weight load balance on the vehicle. When the UWB tag 10 is active, it transmits the encoded information to the closest available network access point 70. This information may then be transmitted via any communication link to a remote location 90. The remote location 90 may process the information and make it available to customers in a number of ways including the World Wide Web. Another feature of this embodiment is that routing of packages may be automated at intermediate locations. The UWB tag 10 transmits its destination to a network access point 70, which may control the flow of parcels within a distribution center.

Thus, it is seen that a system, method and apparatus for tracking objects and improving transportation security are provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. An ultra-wideband device, comprising:
an ultra-wideband transceiver;
a substantially bendable battery; and
a substantially bendable antenna.

2. The ultra-wideband device of claim 1, wherein the transceiver comprises an application specific integrated circuit.

3. The ultra-wideband device of claim 2, wherein the application specific integrated circuit is configured to receive information selected from a group consisting of: a package contents, a package destination, a package origination, a passenger name, a passenger address, a passenger age, a passenger itinerary, and a passenger identification number.

4. The ultra-wideband device of claim 1, wherein the ultra-wideband transceiver transmits by using a plurality of discrete electromagnetic pulses.

5. The ultra-wideband device of claim 4, wherein each of the discrete electromagnetic pulses has a duration that ranges between about 10 picoseconds to about 1 microsecond.

6. The ultra-wideband device of claim 4, wherein each of the discrete electromagnetic pulses has a power that can range between about +30 dBm to about −60 dBm, as measured at a single frequency.

7. The ultra-wideband device of claim 1, wherein the substantially bendable battery comprises a cathode located on a first section of the ultra-wideband device, an anode located on a second section of the ultra-wideband device, and an electrolyte located on either the first or second section of the ultra-wideband device.

8. The ultra-wideband device of claim 1, wherein the substantially bendable antenna comprises a printed antenna.

9. The ultra-wideband device of claim 1, further comprising at least one fastener structured to couple a first section of the ultra-wideband device to a second section of the ultra-wideband device.

10. The ultra-wideband device of claim 1, wherein the ultra-wideband device is selected from a group consisting of: a luggage tag, a package tag, and an identification tag.

11. A security method, the method comprising the steps of:
placing information onto an ultra-wideband device;
sending a first message from the ultra-wideband device to a network access point;
sending a second message from the network access point to a remote location.

12. The method of claim 11, wherein the information placed onto the ultra-wideband device is selected from a group consisting of: a package contents, a package destination, a package origination, a passenger name, a passenger address, a passenger age, a passenger itinerary, and a passenger identification number.

13. The method of claim 11, further comprising the steps of:
determining a location of the ultra-wideband device; and
including the determined location in the first or the second message.

14. The method of claim 11, further comprising the steps of:
including a passenger information in the first or second message; and
comparing the passenger information to a passenger list.

15. The method of claim 14, wherein the passenger information is selected from a group consisting of: a passenger name, a passenger address, a passenger age, a passenger itinerary, and a passenger identification number.

16. The method of claim 11, wherein the remote location is selected from a group consisting of: an airport, a train station, a bus station, and a transportation facility.

17. The method of claim 11, wherein the steps of sending the first and second messages comprises sending a plurality of discrete electromagnetic pulses.

18. The method of claim 16, wherein each of the discrete electromagnetic pulses has a duration that ranges between about 10 picoseconds to about 1 microsecond.

19. The method of claim 16, wherein each of the discrete electromagnetic pulses has a power that can range between about +30 dBm to about −60 dBm, as measured at a single frequency.

20. A method of tracking an object, the method comprising the steps of:
coupling an ultra-wideband device to the object;
placing information onto the ultra-wideband device;
determining a location of the ultra-wideband device;
transmitting a first message from the ultra-wideband device to an access point; and
transmitting a second message from the access point to a remote location.

21. The method of claim 20, wherein the first message or the second message includes the determined location of the ultra-wideband device.

22. The method of claim 20, wherein the information placed onto the ultra-wideband device is selected from a group consisting of: a package contents, a package destination, a package origination, a passenger name, a passenger address, a passenger age, a passenger itinerary, and a passenger identification number.

23. The method of claim 20, wherein the steps of sending the first and second messages comprises sending a plurality of discrete electromagnetic pulses.

24. The method of claim 20, wherein each of the discrete electromagnetic pulses has a duration that ranges between about 10 picoseconds to about 1 microsecond.

25. The method of claim 20, wherein each of the discrete electromagnetic pulses has a power that can range between about +30 dBm to about −60 dBm, as measured at a single frequency.

26. A security system comprising:
a plurality of ultra-wideband devices;
a terminal for placing information on each of the plurality of ultra-wideband devices;
a network access point, configured to communicate with each of the plurality of ultra-wideband devices; and
a remote access point, configured to communicate with the network access point.

27. The security system of claim 26, wherein each of the ultra-wideband devices can communicate with the remote access point.

28. The security system of claim 26, wherein each ultra-wideband device is coupled to an object, and contains information about the object, with the information selected from a group consisting of: a package contents, a package destination, a package origination, a passenger name, a passenger address, a passenger age, a passenger itinerary, and a passenger identification number.

29. The security system of claim 26, wherein each of the ultra-wideband devices includes an ultra-wideband transceiver.

30. The security system of claim 29, wherein the ultra-wideband transceiver transmits by using a plurality of discrete electromagnetic pulses.

31. The security system of claim 30, wherein each of the discrete electromagnetic pulses has a duration that ranges between about 10 picoseconds to about 1 microsecond.

32. The security system of claim 30, wherein each of the discrete electromagnetic pulses has a power that can range between about +30 dBm to about −60 dBm, as measured at a single frequency

33. The security system of claim 26, wherein the network access point is attached to a vehicle.

34. The security system of claim 26, wherein the network access point is attached to a vehicle, the vehicle selected from a group consisting of: an airplane, an automobile, a train, a boat, a car, a bus, and a truck.
